(19) United States
(12) Patent Application Publication
(10) Pub. No.: US 2025/0008286 A1
(43) Pub. Date: Jan. 2, 2025

(54) GENERATION DEVICE, GENERATION METHOD, AND GENERATION PROGRAM

(71) Applicant: NIPPON TELEGRAPH AND TELEPHONE CORPORATION, Tokyo (JP)

(72) Inventors: Lidwina Ayu ANDARINI, Tokyo (JP); Toru NISHIMURA, Tokyo (JP); Takashi KUBO, Tokyo (JP); Kazuya MATSUO, Tokyo (JP); Katsuhiro SUZUKI, Tokyo (JP)

(73) Assignee: NIPPON TELEGRAPH AND TELEPHONE CORPORATION, Tokyo (JP)

(21) Appl. No.: 18/711,882

(22) PCT Filed: Dec. 21, 2021
(86) PCT No.: PCT/JP2021/047419

§ 371 Date: May 21, 2024

(51) Int. Cl. H04S 7/00; G10L 13/02

(52) U.S. Cl. CPC H04S 7/30; G10L 13/02; H04S 2400/11

(57) ABSTRACT

A generation device includes a coefficient acquisition unit that acquires coefficient information of an object on the basis of raw material information of the object when detecting an interaction of the object mapped on cyber space, a sound source selection unit that calculates statistical information in which a type of a sound source corresponding to the interaction of the object and intensity of the sound source are associated with each other and selects sound source information. Further, there is a voice synthesis unit that generates synthesized sound source information obtained by synthesizing the sound source information on the basis of the statistical information and the sound source information and generates three-dimensional sound source information obtained by converting the synthesized sound source information into three-dimension by executing three-dimensional sound rendering on the basis of the position information to the synthesized sound source information.

### TECHNICAL FIELD

The present invention relates to a generation device, a generation method, and a generation program.

### BACKGROUND ART

Digital twin (DT) technique for mapping a real space target onto cyber space is realized by the progress of ICT (Information and Communication Technology) technology and is attracting attention. The DT is configured to map and accurately express a shape, a state, a function, and the like of a real world target such as a production machine in a factory, an engine of an aircraft, an automobile.

By using this DT, current analysis, future prediction, simulation of possibility, and the like regarding the target can be performed in the cyber space. Further, cyber space benefit such as intelligently controlling the real world target on the basis of the result, for example, benefit of facilitating utilization of the ICT technology, can be fed back to the real world target.

In the future, increasing use of converting various real world targets to DTs is expected to increase demand for cooperation between industries and large-scale simulations by interacting (interaction) or combining different and diverse DTs across industries.

When a user himself or herself uses the DT or the DT is used by the DT (human DT) of the user, the user or the human DT need to recognize the interaction between DTs as in the real world.

The human recognizes a real world event by using five senses. For this reason, in order to recognize the interaction between DTs, it is necessary to digitize visual, auditory, olfactory and taste information of the interaction. In this case, attention is paid to digitization of sound information related to the auditory information.

FIG. 10 is a diagram for explaining an image of generating the sound related to converting mono to the DT. In a concept of DTC (Digital Twin Computing), by digitizing the mono in the real world, it is possible to process and edit the mono or to interact with another mono in digital space.

In an example shown in FIG. 10, a mono 11 is generated by digitizing a real world mono 10. Also, the mono 11 and another mono 12 are made to interact to generate a sound “pock”. The mono 11 is processed and edited to generate a mono 11a, and the mono 11a and another mono 12a are made to interact to generate a sound “con”. The mono 11 is processed and edited to generate a mono 11b, and the mono 11b and another mono 12b are made to interact to generate a sound “challin”.

In order to generate the sound described in FIG. 10, a sound may be manually assigned. FIG. 11 is a diagram for explaining a manual assigning procedure of a sound FB. As shown in FIG. 11, first, a virtual object is defined (step S10). For example, the virtual objects ob1-1, ob1-2, ob1-3, ob2-1, ob2-2 and ob2-3 are defined.

Subsequently, the interaction which can be performed by the virtual object is defined (step S11). In an example shown in FIG. 11, an interaction int1 between the virtual object 2-3 and the virtual object 1-1 is defined. Finally, a sound is assigned to the interaction int1 (step S12).

Although the above-mentioned prior art is a technique for manually assigning the sound, there is a prior art for analyzing video to synthesize an effect voice. FIG. 12 is a flowchart showing the processing procedure of the prior art in which video is analyzed and effect voice is synthesized.

As shown in FIG. 12, in the prior art, material and interaction of the object are selected (step S20). In an example shown in FIG. 12, the material is selected from a plurality of candidates included in a group G1, and the interaction is selected from a plurality of candidates included in a group G2.

In the prior art, sound textures for the selected material and interaction are generated (step S21). The sound textures include sound texture so1 of each material and sound texture so2 of each interaction.

In the prior art, a two-dimensional video 17 is analyzed by using an NN (Neural Network) 16, and an appropriate sound 18 obtained by combining sound textures so1 and so2 is synthesized (step S22).

### CITATION LIST

### Non Patent Literature

[NPL 1] Andrew Owens, et al. “Visually Indicated Sounds”
[NPL 2] Josh H. McDermott, Eero P. Simoncelli, “Sound Texture Perception via Statistics of the Auditory Periphery: Evidence from Sound Synthesis”
[NPL 3] Xiao-li Zhong, Bo-sun Xie, “Head-Related Transfer Functions and Virtual Auditory Display”

### SUMMARY OF INVENTION

### Technical Problem

In the prior art described in FIG. 12, since the two-dimensional video 17 is analyzed and sound texts so1 and so2 for the material and the interaction of the object are synthesized, there is a problem that it is impossible to apply the prior art as it is to three-dimensional space requiring a position of a sound source.

Unlike the two-dimensional sound synthesis, in the sound synthesis in the three-dimensional space, the sound is unnatural to the user unless the position of the sound source is appropriately set. FIG. 13 is a diagram showing an example of the three-dimensional space. In the three-dimensional space 15 shown in FIG. 13, an object 15b exists at the position in upper right front of a user 15a. The sound with the object 15b as the sound source is unnatural to the user 15a unless the sound is set to be heard from the upper right front of the user 15a.

The present invention has been made in view of the above, and an object of the present invention is to provide a generation device, a generation method, and a generation program capable of synthesizing a realistic sound in the three-dimensional space.

### Solution to Problem

In order to solve the above-described problem and achieve the object, it is characterized in that a generation device include a coefficient acquisition unit that acquires coefficient information of an object on the basis of raw material information of the object when detecting an interaction of the object mapped on cyber space, a sound source selection unit that calculates statistical information in which a type of a sound source corresponding to the interaction of the object and intensity of the sound source are associated with each other and selects sound source information corresponding to the statistical information by inputting position information, shape information, and the coefficient information of the object to a machine learning model, and a voice synthesis unit that generates synthesized sound source information obtained by synthesizing the sound source information on the basis of the statistical information and the sound source information and generates three-dimensional sound source information obtained by converting the synthesized sound source information into three-dimension by executing three-dimensional sound rendering on the basis of the position information to the synthesized sound source information.

### Advantageous Effects of Invention

According to the present invention, the realistic sound can be synthesized even in the three-dimensional space.

### BRIEF DESCRIPTION OF DRAWINGS

FIG. 1 is a diagram for explaining DT data used in a present example.

FIG. 2 is a functional block diagram showing a configuration of a generation device according to the present example.

FIG. 3 is a diagram showing an example of a sound element stored in a sound source DB.

FIG. 4 is a diagram for explaining processing of a selection unit.

FIG. 5 is a flowchart showing a processing procedure of the generation device according to the present example.

FIG. 6 is a flowchart showing a processing procedure of coefficient acquisition processing.

FIG. 7 is a flowchart showing a processing procedure of sound source selection processing.

FIG. 8 is a flowchart showing a processing procedure of voice synthesis processing.

FIG. 9 is a diagram showing an example of a computer that executes a generation program.

FIG. 10 is a diagram for explaining a sound generation image related to converting a mono to DT.

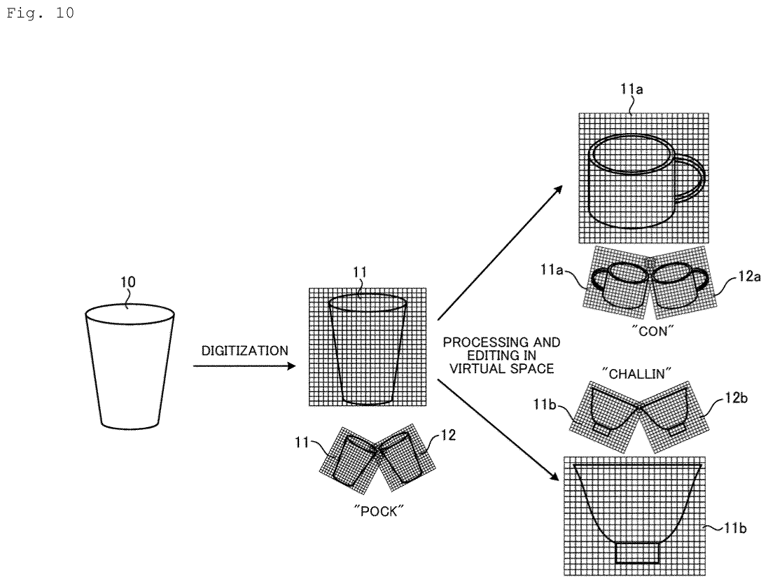

FIG. 11 is a diagram for explaining a manual assigning procedure of sound FB.

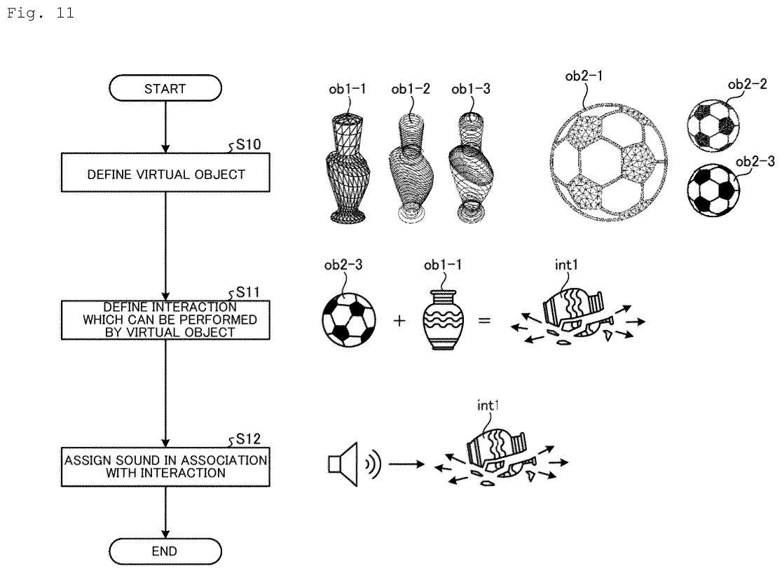

FIG. 12 is a flowchart showing a processing procedure of prior art in which video is analyzed and effect voice is synthesized.

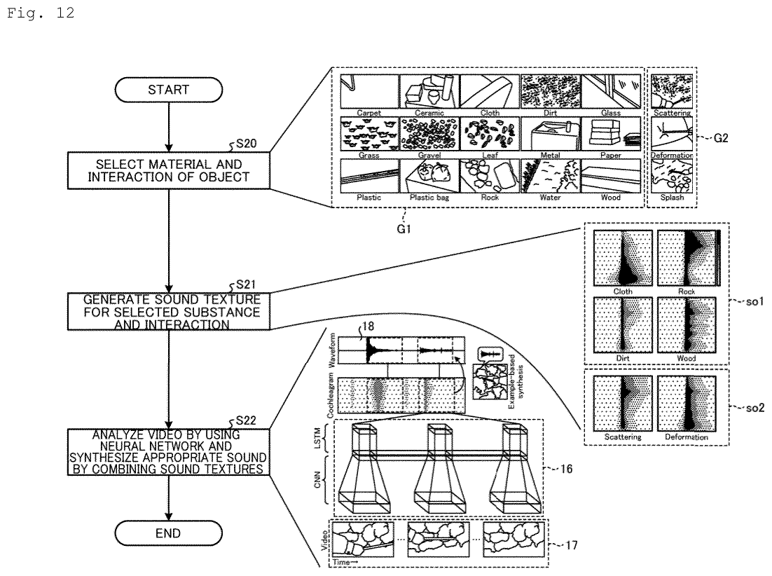

FIG. 13 is a diagram showing an example of three-dimensional space.

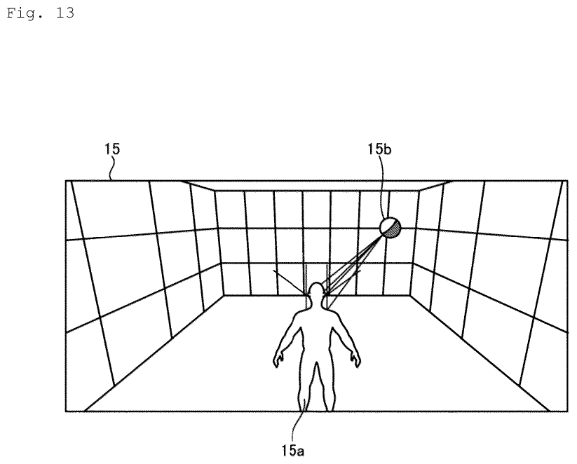

### DESCRIPTION OF EMBODIMENTS

Hereinafter, examples of the generation device, the generation method, and the generation program disclosed in the present application will be described in detail with reference to the drawings. Note that these examples are not intended to limit the scope of the present invention.

### Examples

In the DT (Digital Twin) technique, a real space object is mapped onto cyber space (digital three-dimensional space). Data of the object mapped onto the cyber space is expressed as DT data. A user can view the DT data of the object mapped onto the cyber space by using VR (Virtual Reality) or AR (Augmented Reality).

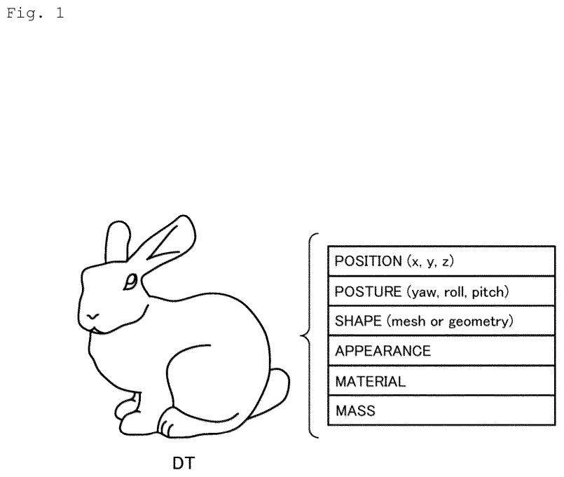

FIG. 1 is a diagram for explaining the DT data that is used in the present example. As shown in FIG. 1, the DT data includes a position, a posture, a shape, an appearance, a material, and a mass as parameters.

The position is position coordinates (x, y, z) of the object which uniquely specifies the position of the object. The posture is posture information (yaw, roll, pitch) of the object which uniquely specifies an orientation of the object. The shape is mesh information or geometry information representing the shape of a three-dimensional object to be displayed. The appearance is color information of an object surface. The material is information indicating the material of the object. The mass is information indicating the mass of the object.

A generation device according to the present example acquires coefficient information (friction coefficient, attenuation coefficient) of the object on the basis of raw material information (information including the shape, the mass, and the material) of the object when detecting an interaction of the object in the cyber space.

The generation device calculates statistical information in which a type of a sound source corresponding to the interaction of the object and intensity of the sound source are associated with each other, and selects sound source information corresponding to the statistical information from a sound source DB by inputting the position information, the shape information, and the coefficient information of the object to a trained machine learning model.

The generation device generates synthesized sound source information obtained by synthesizing the sound source information on the basis of the statistical information and the sound source information. The generation device generates three-dimensional sound source information by executing three-dimensional sound rendering on the basis of the position information of the object to the synthesized sound source information, and outputs the three-dimensional sound source information to a device such as a VR device or an AR device.

The generation device executes the above-mentioned processing to generate and output the realistic three-dimensional sound source information. The three-dimensional sound source information is a natural sound source for a user experiencing the cyber space.

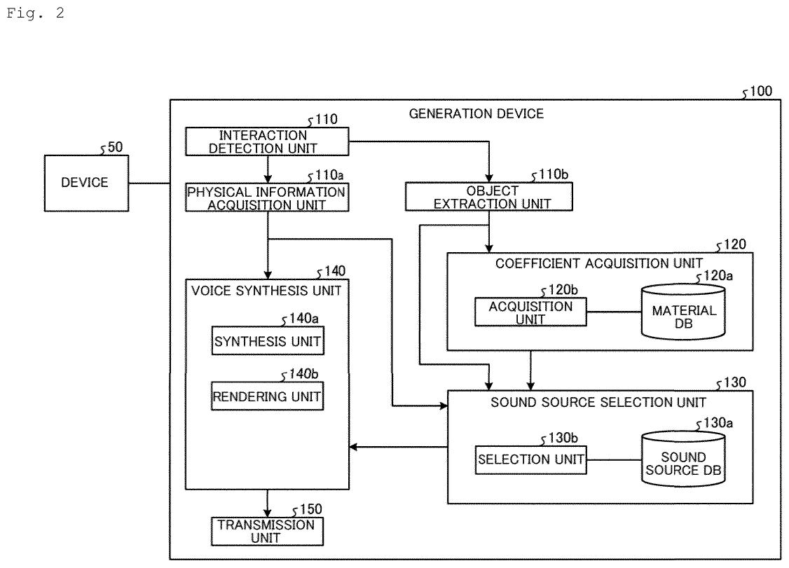

Next, a configuration example of the generation device according to the present example will be described. FIG. 2 is a functional block diagram showing a configuration of the generation device according to the present example. As shown in FIG. 2, this generation device 100 is connected to a device 50. For example, the device 50 corresponds to the VR device, the AR device, and the like. The device 50 is a device for mapping the real space object onto the cyber space, and the DT data of each object in the cyber space is defined by the data shown in FIG. 1. When each object is a dynamic object, it moves on the cyber space in accordance with preset scenario information to generate the interaction. The dynamic object may generate the interaction with another dynamic object or generate the interaction with a static object.

The device 50 outputs the DT data (time-series DT data) corresponding to each object to the generation device 100. In addition, the device 50 acquires the three-dimensional sound source information generated by the generation device 100, and generates the three-dimensional sound source in the cyber space.

In the example shown in FIG. 2, the device 50 and the generation device 100 are separately shown, but one device having a function of the device 50 and a function of the generation device 100 may be used.

The generation device 100 includes an interaction detection unit 110, a physical information acquisition unit 110a, an object extraction unit 110b, a coefficient acquisition unit 120, a sound source selection unit 130, and a voice synthesis unit 140.

The interaction detection unit 110 acquires the DT data of each object from the device 50, and detects the interaction of the object. It is assumed that the interaction is defined in advance. For example, the interaction detection unit 110 detects a collision (interaction) when a distance between a plurality of objects becomes less than a threshold value.

The interaction detection unit 110 outputs the target object information to the physical information acquisition unit 110a, and outputs the scenario information to the object extraction unit 110b when detecting the interaction. The target object information includes the DT data of fixed time interval before and after the detection of the interaction that is DT data of the object related to the interaction. The scenario information includes a type of the interaction, DT data of the object related to the interaction, and the like.

The physical information acquisition unit 110a calculates the shape information, the position information, and movement information of the object at the time of interaction detection on the basis of the target object information. For example, the shape of the object includes information on a collision area. The position information includes information on the three-dimensional position of the object on the cyber space at a point of time when the interaction is detected. The movement information includes information on a movement speed and a movement direction immediately before the interaction is detected.

The physical information acquisition unit 110a outputs the shape information, the position information, and the movement information to the sound source selection unit 130. The physical information acquisition unit 110a outputs the position information and the movement information to the voice synthesis unit 140.

The object extraction unit 110b extracts raw material information of the object related to the interaction on the basis of the scenario information. The raw material information includes information on the shape, the mass, and the material of the object. The object extraction unit 110b outputs the extracted raw material information to the coefficient acquisition unit 120 and the sound source selection unit 130.

The coefficient acquisition unit 120 has a material DB (DataBase) 120a and an acquisition unit 120b.

The material DB 120a stores information on the friction coefficient and the attenuation coefficient of substance corresponding to combination of the shape, the mass, and the material of the object.

The acquisition unit 120b acquires the friction coefficient and the attenuation coefficient corresponding to the raw material information on the basis of the raw material information (shape, mass, material) and the material DB 120a. The acquisition unit 120b sets the acquired friction coefficient and attenuation coefficient to coefficient information, and outputs the coefficient information to the sound source selection unit 130.

The sound source selection unit 130 has a sound source DB 130a and a selection unit 130b.

The sound source DB 130a stores a plurality of sound elements. The sound elements include sinusoidal information and sound texture information of each different frequency. The sound textures include information related to small recordings and cochleagram.

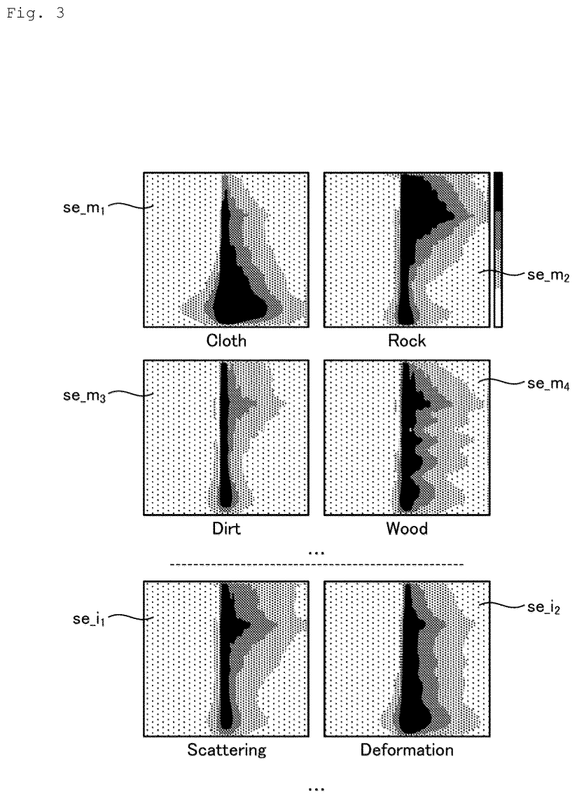

For example, the sound source DB 130a stores the sound sources of the sound elements of a plurality of materials and the sound sources of the sound elements of a plurality of interactions. FIG. 3 is a diagram showing an example of sound elements stored in the sound source DB 130a. In FIG. 3, sound elements related to the material se_m₁, se_m₂, se_m₃, se_m₄, . . . , se_mₙ and sound elements related to the interaction se_i₁, se_i₂, . . . , se_iₙ are described. Each sound element is information in which frequency, time, and intensity are associated with each other. Each sound element identifies the material and the interaction.

There are 23 types of materials, for example, Brick, Carpet, Ceramic, Fabric, Foliage, Food, Blass, Hair, Leather, Metal, Mirror, Other, Painted, Paper, Plastic, Pol, Stone, Skin, Sky, Tile, Wallpaper, Water, and Wood.

The selection unit 130b acquires the position information and the shape information of the object from the physical information acquisition unit 110a. The selection unit 130b acquires the coefficient information from the coefficient acquisition unit 120.

The selection unit 130b inputs the position information, the shape information, and the coefficient information of the object to the trained machine learning model to calculate the statistical information corresponding to the interaction of the object. The selection unit 130b selects the sound source information corresponding to the statistical information from the sound source DB 130a. The selection unit 130b outputs the statistical information and the sound source information to the voice synthesis unit 140.

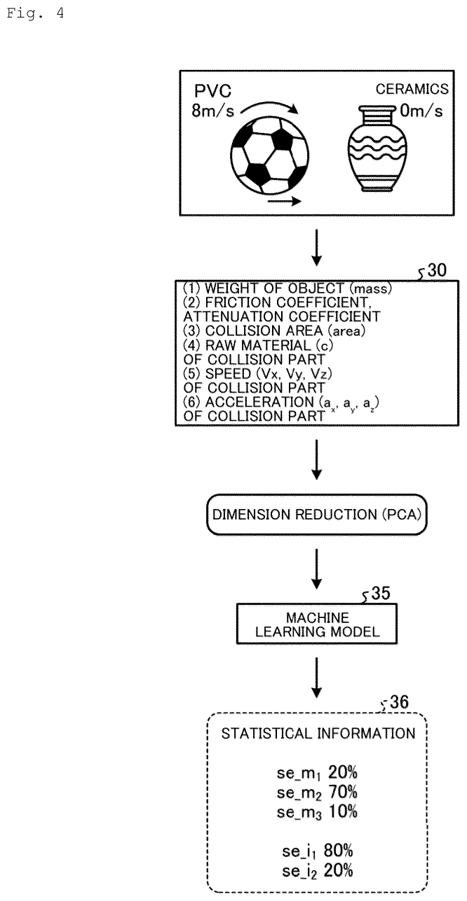

FIG. 4 is a diagram for explaining processing of the selection unit. In the example shown in FIG. 4, the position information, the shape information, and the coefficient information of the object are collected to be object related information 30. For example, the object related information 30 includes the following information (1) to (6).
(1) Mass of object
(2) Friction coefficient, attenuation coefficient
(3) Collision area
(4) Raw material of collision part
(5) Speed of collision part
(6) Acceleration of collision part

The selection unit 130b performs dimension reduction by performing PCA (Principal Component Analysis) to the object related information 30. The selection unit 130b may perform the dimension reduction by using any conventional technique. The selection unit 130b may select any information among (1) to (6) to perform the dimension reduction.

The selection unit 130b calculates the statistical information 36 by inputting the object related information 30 subjected to dimension reduction to the machine learning model 35. The machine learning model 35 corresponds to a Recurrent Neural Network, a Convolutional Neural Network, etc.

For example, the identification information of each sound source is associated with the intensity of the sound source in the statistical information. The statistical information 36 includes the sound elements related to the materials se_m₁ 20%, se_m₂ 70%, and se_m₃ 10% and the sound elements related to the interactions se_i₁ 80% and se_i₂ 20%. In the statistical information 36, when the intensities of the sound elements related to the materials are summed up, the sum becomes 100%. In addition, the intensities of the sound elements related to the interactions are summed up, the sum becomes 100%.

The selection unit 130b selects the sound source information corresponding to the statistical information 36 from the sound source DB 130a. The selection unit 130b outputs the statistical information (for example, the statistical information 36) and the sound source information to the voice synthesis unit 140.

Here, it is assumed that the machine learning model 35 used by the selection unit 130b is trained in advance on the basis of teacher data composed of a set of input data and a correct answer label. The input data corresponds to the object related information 30. The correct answer label is information in which the identification information of the sound source and the intensity of the sound source are associated with each other.

Let us return to the description of FIG. 2. The voice synthesis unit 140 acquires the position information and the movement information from the physical information acquisition unit 110a. The voice synthesis unit 140 acquires the statistical information and the sound source information from the sound source selection unit 130. The voice synthesis unit 140 generates the three-dimensional sound source information on the basis of the statistical information, the sound source information, the position information, and the movement information.

The voice synthesis unit 140 has a synthesis unit 140a and a rendering unit 140b.

The synthesis unit 140a generates synthesized sound source information obtained by synthesizing the sound source information on the basis of the statistical information and the sound source information. For example, the synthesis unit 140a connects the sound elements of the sound source information to generate the synthesized sound source information by using NPL 2.

The synthesis unit 140a outputs the generated synthesized sound source information to the rendering unit 140b.

The rendering unit 140b generates the three-dimensional sound source information (3D waveform) obtained by converting the synthesized sound source information into three-dimension by executing three-dimensional sound rendering on the basis of the synthesized sound source information, the position information and the movement information. For example, the rendering unit 140b executes the three-dimensional sound rendering by using NPL 3. The rendering unit 140b outputs the three-dimensional sound source information to a transmission unit 150.

The transmission unit 150 transmits the three-dimensional sound source information to the device 50.

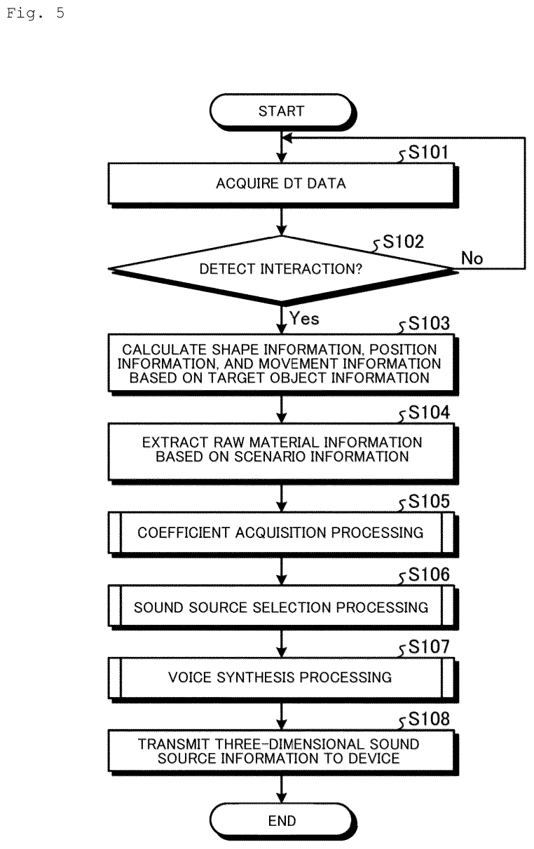

Next, processing procedure of the generation device 100 according to the present example will be described. FIG. 5 is a flowchart showing the processing procedure of the generation device according to the present example. As shown in FIG. 5, the interaction detection unit 110 of the generation device 100 acquires the DT data from the device 50 (step S101). The interaction detection unit 110 of the generation device 100 shifts to the step S101 when detecting no interaction (step S102, No).

On the other hand, the interaction detection unit 110 shifts to a step S103 when detecting the interaction (step S102, Yes). The physical information acquisition unit 110a of the generation device 100 calculates the shape information, the position information, and the movement information related to the interacted object on the basis of the target object information acquired from the interaction detection unit 110 (step S103).

The object extraction unit 110b of the generation device 100 extracts the raw material information related to the interacted object on the basis of the scenario information acquired from the interaction detection unit 110 (step S104).

The coefficient acquisition unit 120 of the generation device 100 executes coefficient acquisition processing (step S105). The sound source selection unit 130 of the generation device 100 executes sound source selection processing (step S106). The voice synthesis unit 140 of the generation device 100 executes voice synthesis processing (step S107).

The transmission unit 150 of the generation device 100 transmits the three-dimensional sound source information to the device 50 (step S108).

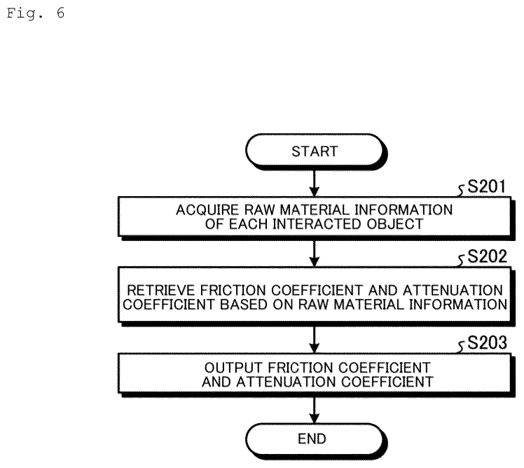

Next, an example of the processing procedure of the coefficient acquisition processing shown in step S105 of FIG. 5 will be described. FIG. 6 is a flowchart showing the processing procedure of the coefficient acquisition processing. As shown in FIG. 6, the acquisition unit 120b of the coefficient acquisition unit 120 acquires the raw material information of each interacted object (step S201).

The acquisition unit 120b retrieves the friction coefficient and the attenuation coefficient from the material DB 120a on the basis of the raw material information (step S202). The acquisition unit 120b outputs the friction coefficient and the attenuation coefficient to the sound source selection unit 130 (step S203).

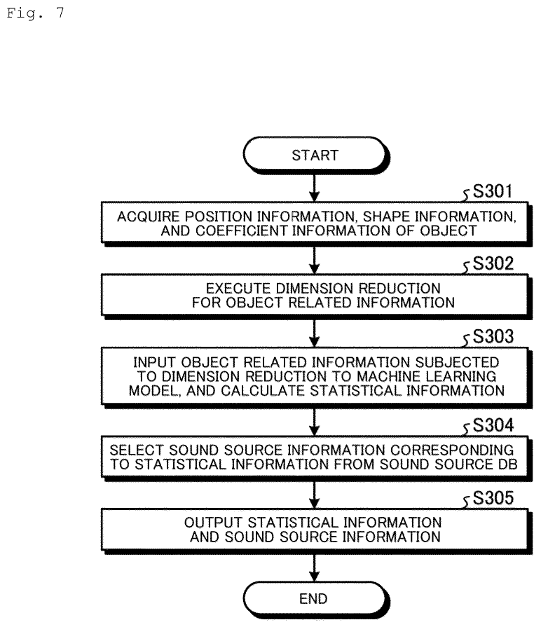

Next, an example of the processing procedure of the sound source selection processing shown in the step S106 of FIG. 5 will be described. FIG. 7 is a flowchart showing the processing procedure of the sound source selection processing. As shown in FIG. 7, the selection unit 130b of the sound source selection unit 130 acquires the position information, the shape information and the coefficient information of the object (step S301).

The selection unit 130b executes the dimension reduction to the object related information (step S302). The selection unit 130b inputs the object related information subjected to the dimension reduction to the machine learning model, and calculates the statistical information (step S303).

The selection unit 130b acquires the sound source information corresponding to the statistical information from the sound source DB 130a (step S304). The selection unit 130b outputs the statistical information and the sound source information to the voice synthesis unit 140 (step S305).

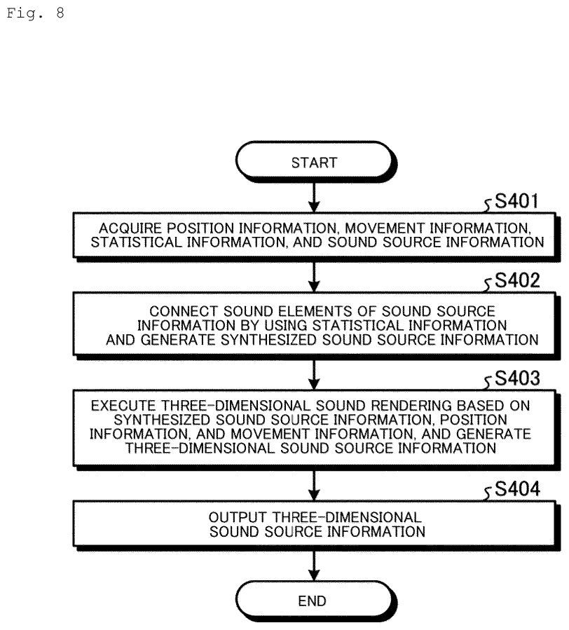

Next, an example of the processing procedure of the voice synthesis processing shown in the step S107 of FIG. 5 will be described. FIG. 8 is a flowchart showing the processing procedure of the voice synthesis processing. As shown in FIG. 8, the synthesis unit 140a of the voice synthesis unit 140 acquires the position information, the movement information, the statistical information, and the sound source information (step S401).

The synthesis unit 140a generates the synthesized sound source information by connecting the sound elements of the sound source information on the basis of the statistical information (step S402). The rendering unit 140b of the voice synthesis unit 140 executes the three-dimensional sound rendering on the basis of the synthesized sound source information, the position information, and the movement information, and generates the three-dimensional sound source information (step S403).

The rendering unit 140b outputs the three-dimensional sound source information (step S404).

Next, the effect of the generation device 100 according to the present example will be described. The generation device 100 acquires the coefficient information (friction coefficient, attenuation coefficient) of the object on the basis of the raw material information (information including the shape, the mass, and the material) of the object when detecting the interaction of the object on the cyber space. The generation device 100 calculates the statistical information in which the type of the sound source corresponding to the interaction of the object and the intensity of the sound source are associated with each other, and selects the sound source information corresponding to the statistical information from the sound source DB 130a by inputting the position information, the shape information, and the coefficient information of the object to the trained machine learning model. The generation device 100 generates the synthesized sound source information obtained by synthesizing the sound source information on the basis of the statistical information and the sound source information, generates the three-dimensional sound source information by executing the three-dimensional sound rendering on the basis of the position information of the object on the synthesized sound source information, and outputs the synthesized sound source information to the device 50.

The generation device 100 can generate and output the realistic three-dimensional sound source information by executing the above-mentioned processing. The three-dimensional sound source information is the natural sound source for the user experiencing the cyber space by using the device 50.

The generation device 100 executes the dimension reduction on the position information, the shape information, and the coefficient information, and calculates the statistical information by inputting information to be an execution result of the dimension reduction into the machine learning model. Accordingly, the cost for using the machine learning model can be reduced.

The generation device 100 acquires the speed of the collision part and the acceleration of the collision part of the two objects, and the positions of the two objects as the position information when detecting the collision of the two objects as the interaction. By using such position information, the three-dimensional sound source information on the cyber space can be generated with high accuracy.

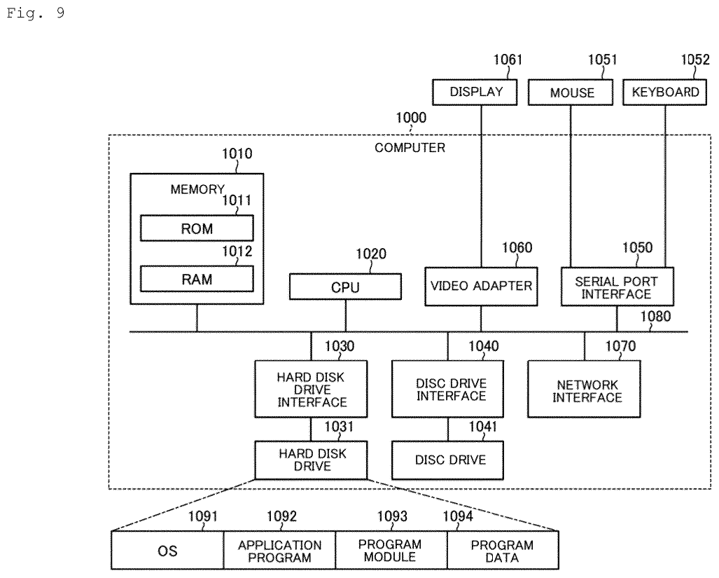

Subsequently, an example of a computer that performs a generation program will be described below. FIG. 9 is a diagram showing an example of the computer that executes the generation program. A computer 1000 includes a memory 1010, a CPU 1020, a hard disk drive interface 1030, a disc drive interface 1040, a serial port interface 1050, a video adapter 1060, and a network interface 1070, for example. These respective units are connected by a bus 1080.

The memory 1010 includes a ROM (Read Only Memory) 1011 and a RAM 1012. The ROM 1011 stores, for example, a boot program such as a BIOS (Basic Input Output System). The hard disk drive interface 1030 is connected to a hard disk drive 1031. The disc drive interface 1040 is connected to a disc drive 1041. A removable storage medium such as a magnetic disc or an optical disc is inserted into the disc drive 1041, for example. A mouse 1051 and a keyboard 1052 are connected to the serial port interface 1050, for example. A display 1061 is connected to the video adapter 1060, for example.

Here, an OS 1091, an application program 1092, a program module 1093, and program data 1094 are stored in the hard disk drive 1031, for example. Each piece of information described in the above-mentioned embodiment is stored in the hard disk drive 1031 or the memory 1010, for example.

In addition, the generation program is stored in the hard disk drive 1031, for example, as the program module 1093 in which instructions executed by the computer 1000 are described. Specifically, the program module 1093 in which respective processes for executing the interaction detection unit 110, the physical information acquisition unit 110a, the object extraction unit 110b, the coefficient acquisition unit 120, the sound source selection unit 130, the voice synthesis unit 140, the transmission unit 150 are described is stored in the hard disk drive 1031.

Further, data used for information processing by the generation program is stored in, for example, the hard disk drive 1031 as the program data 1094. Thereafter, the CPU 1020 reads the program module 1093 and the program data 1094 stored in the hard disk drive 1031 into the RAM 1012 when necessary, and executes each procedure described above.

Note that the storage of the program module 1093 and the program data 1094 related to the generation program is not limited to the case where the program module 1093 and the program data 1094 are stored in the hard disk drive 1031, and the program module 1093 and the program data 1094 may be stored in, for example, a detachable storage medium and may be read by the CPU 1020 via the disc drive 1041. Alternatively, the program module 1093 and the program data 1094 related to the generation program may be stored in another computer connected via a network such as a LAN or a WAN (Wide Area Network) and may be read by the CPU 1020 via the network interface 1070.

Although the embodiments to which the invention made by the present inventor is applied have been described above, the present invention is not limited by the descriptions and drawings forming a part of the disclosure of the present invention according to the embodiments. That is to say, other embodiments, examples, operation techniques, and the like made by those skilled in the art on the basis of the embodiment are all included in the scope of the present invention.

### REFERENCE SIGNS LIST

50 Device
100 Generation device
110 Interaction detection unit
110a Physical information acquisition unit
110b Object extraction unit
120 Coefficient acquisition unit
120a Material DB
120b Acquisition unit
130 Sound source selection unit
130a Sound source DB
130b Selection unit
140 Voice synthesis unit
140a Synthesis unit
140b Rendering unit
150 Transmission unit

1. A generation device comprising:
coefficient acquisition circuitry configured to acquire coefficient information of an object on the basis of raw material information of the object when detecting an interaction of the object mapped on cyber space;
sound source selection circuitry configured to calculate statistical information in which a type of a sound source corresponding to the interaction of the object and intensity of the sound source are associated with each other and select sound source information corresponding to the statistical information by inputting position information, shape information, and the coefficient information of the object to a machine learning model; and
voice synthesis circuitry configured to generate synthesized sound source information obtained by synthesizing the sound source information on the basis of the statistical information and the sound source information and generate three-dimensional sound source information obtained by converting the synthesized sound source information into three-dimension by executing three-dimensional sound rendering on the basis of the position information to the synthesized sound source information.

2. The generation device according to claim 1, wherein:
the sound source selection circuitry performs dimension reduction on the position information, the shape information, and the coefficient information, inputs information to be an execution result of the dimension reduction into the machine learning model, and calculates the statistical information.

3. The generation device according to claim 1, further comprising:
object information acquisition circuitry configured to acquire a speed of a collision part and an acceleration of the collision part of two objects and positions of the two objects as the position information when detecting the collision of the two objects as the interaction.

4. A generation method, comprising:
acquiring coefficient information of an object on the basis of raw material information of the object when detecting an interaction of the object mapped on cyber space;
calculating statistical information in which a type of a sound source corresponding to the interaction of the object and intensity of the sound source are associated with each other and selecting sound source information corresponding to the statistical information by inputting position information, shape information, and the coefficient information of the object to a machine learning model; and
generating synthesized sound source information obtained by synthesizing the sound source information on the basis of the statistical information and the sound source information and generating three-dimensional sound source information obtained by converting the synthesized sound source information into three-dimension by executing three-dimensional sound rendering on the basis of the position information to the synthesized sound source information.

5. A non-transitory computer readable medium storing a generation program for causing a computer to perform the method of claim 4.
